(19) United States
(12) Patent Application Publication
(10) Pub. No.: US 2012/0031167 A1
(43) Pub. Date: Feb. 9, 2012

(54) METHOD AND DEVICE FOR CONTROLLING OR MONITORING FIRING SYSTEMS AND FOR MONITORING BUILDINGS HAVING GAS BURNERS

(75) Inventors: Jia Chen, Munchen (DE); Andreas Hangauer, Munchen (DE); Hans Link, Sinzheim (DE); Rainer Strzoda, Munchen (DE)

(73) Assignee: SIEMENS AKTIENGESELLSCHAFT, MÜNCHEN (DE)

(21) Appl. No.: 13/003,443

(22) PCT Filed: Jul. 3, 2009
(86) PCT No.: PCT/EP09/58384

§ 371 Date: Aug. 1, 2011

(30) Foreign Application Priority Data
Jul. 9, 2008 (DE) 10 2008 032 223.7
Feb. 17, 2009 (DE) 10 2009 009 314.1

(51) Int. Cl. G01N 7/00

(52) U.S. Cl. 73/23.31

(57) ABSTRACT

A method for controlling or monitoring firing systems and for monitoring buildings having gas burners using spectroscopy, provides at least one wavelength-tunable monochromatic light source. An absorption spectrum of a measuring gas is received with at least one photodetector in an absorption path with spectral tuning of the light source, and the concentration of target gases carbon monoxide (CO) and methane (CH4) can be determined simultaneously during tuning of the light source. A device for carrying out the method includes a monochromatic laser diode, in particular a VCSEL, an absorption path in the exhaust gas region or a space endangered by leakage, a photodetector for receiving light passed through the absorption path, and an evaluation unit for determining the concentration of target gases based on the absorption spectrum covered during the laser or laser diode tuning. The method and device are applied in laser-optical gas sensors in gas firing systems.

The invention relates to the simultaneous detection of the concentration of carbon monoxide and methane by laser absorption spectroscopy. A device for carrying out the method is furthermore provided. The method and the device are used to control and monitor firing systems, for example in buildings in which gas burners are used.

The physical fact is used that in the absorption bands of carbon monoxide (CO), for example at a wavelength of 2.35 μm, the absorption lines of methane (CH₄) or also water (H₂O) likewise occur in addition to the absorption line of carbon monoxide. By analyzing the spectrum which is observed in laser spectroscopy, it is possible to determine the concentrations of all gases present in the gas to be measured, which have an absorption line in this range.

For the detection of one or more gases in an absorption path, a plurality of gases and their concentrations may be determined by using spectroscopy, in particular laser spectroscopy. For simultaneous detection of the three gas components mentioned above, only a single tunable monochromatic laser source is required. In particular, a so-called VCSEL may be used as the light source. This is a small high-power laser, which is used in optical transmission technology. This VCSEL (vertical cavity surface emitting laser) is distinguished by a high data rate and, the same time, requires only a low energy consumption.

Metal oxide semiconductor gas sensors are furthermore known in the prior art, which can simultaneously detect at least two gases in a measurement gas volume. However, these sensors require that a gas-sensitive layer be brought to different temperature levels so that the gas-sensitive layer has the optimal temperature for the respective detection of the gas. This entails temperature cycle processes, that is to say heating and cooling processes.

For particular types of firing technology control or monitoring, very short reaction times are desired in a hot gas control or safety system. Such reaction times of the sensors for measuring at least two gas components cannot, however, be provided by metal oxide semiconductor sensors.

It is therefore an object of the invention to provide a method and a device for simultaneously detecting the concentration of carbon monoxide and methane.

This object is achieved by the feature combinations of the corresponding main claims.

Advantageous refinements may be found in the dependent claims.

The invention is based on the use of spectroscopy with a wavelength-tunable monochromatic light source. To this end, in particular, laser diodes are used.

The invention relies on the simultaneous detection of the carbon monoxide and methane concentrations in laser absorption spectroscopy with a wavelength-tunable monochromatic light source, in particular laser spectroscopy, wherein a gas to be measured is exposed in an absorption path and an absorption spectrum of the gas to be measured located in the absorption path is recorded by means of a photodetector, at least the absorption bands of carbon monoxide and methane being present. For the purpose of control and/or monitoring of firing systems and for monitoring buildings having gas burners, the use of this method offers substantial advantages.

The simultaneous concentration measurement of carbon monoxide and methane with a tunable monochromatic light source, for example a VCSEL, allows in particular three applications:

1. Control of firing systems
2. Safety monitoring of firing systems
3. Monitoring of buildings having gas burners

For rapid detection of the concentration of both carbon monoxide and methane, it is advantageous to use a laser diode, in particular a VCSEL. The frequency of the laser diode is selected so that the absorption bands of both carbon monoxide and methane are scanned during monochromatic tuning. Recorded absorption spectra are not just analyzed for the existence of these gases; rather, the concentrations of the gases are determined. This may be done by analyzing the corresponding amplitudes in respective bands.

It is particularly advantageous to position a reference gas cell either directly in an exhaust gas flow of a firing system or in a bypass. The reference cell advantageously contains at least one target gas, so that a reference measurement can be performed for it. In order to control or optimize a combustion process, for example, monitoring of the carbon monoxide concentration may be used. Correspondingly, an optimal combustion status can be monitored and controlled by correcting deviations from a setpoint value.

The method may advantageously be used in buildings which are heated by gas burners. Besides the carbon monoxide concentration, the methane concentration may also be monitored, the fuel used comprising proportions of methane. For monitoring exhaust gas systems and buildings with gas heating systems, control or monitoring may be configured so that the carbon monoxide and methane concentrations are kept sufficiently far away from applicable explosion limits in the event both of a leak in gas supplies and the leakage of exhaust gas lines.

Since processes in the combustion or in the exhaust gas cannot be revealed sufficiently by merely detecting and determining the concentration of carbon monoxide, it is important simultaneously to determine at least one value of the methane concentration in order to identify malfunctions of firing systems definitively.

Exemplary embodiments will be described below with the aid of schematic appended figures.

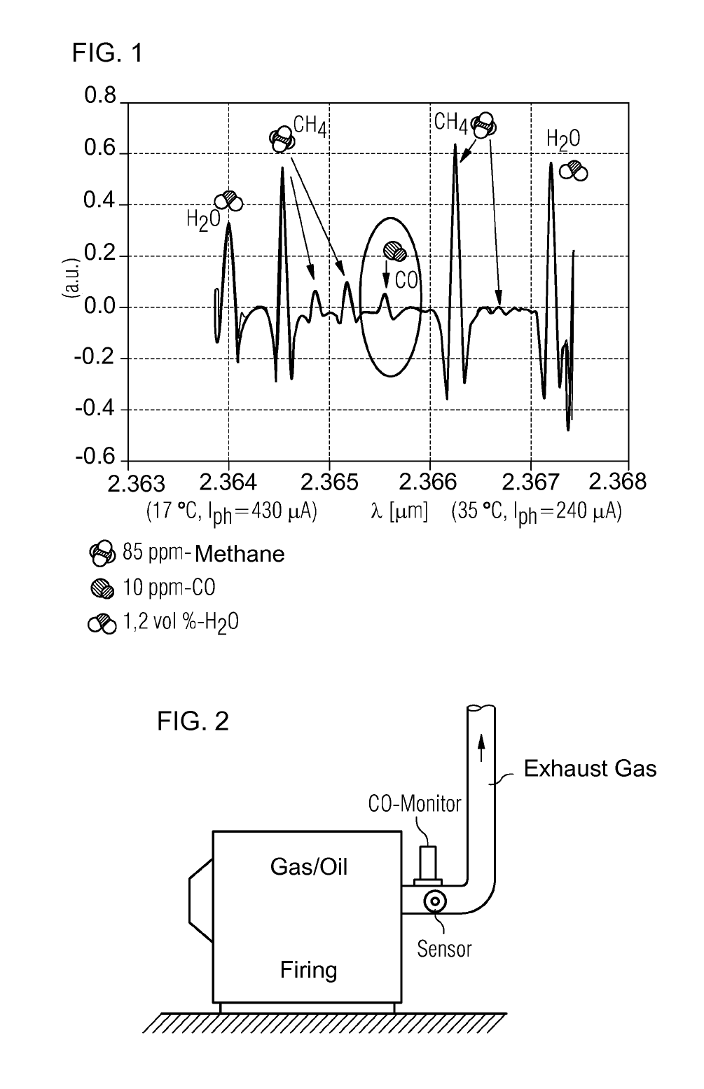

FIG. 1 shows a measured derivative spectrum in the range of 2363-2368 μm with the absorption lines of CO/10 ppm, methane/85 ppm and water/12000 ppm, the measurement having been carried out using a VCSEL,

FIG. 2 shows the installation site of a CO/CH₄ sensor in the exhaust gas of a gas burner,

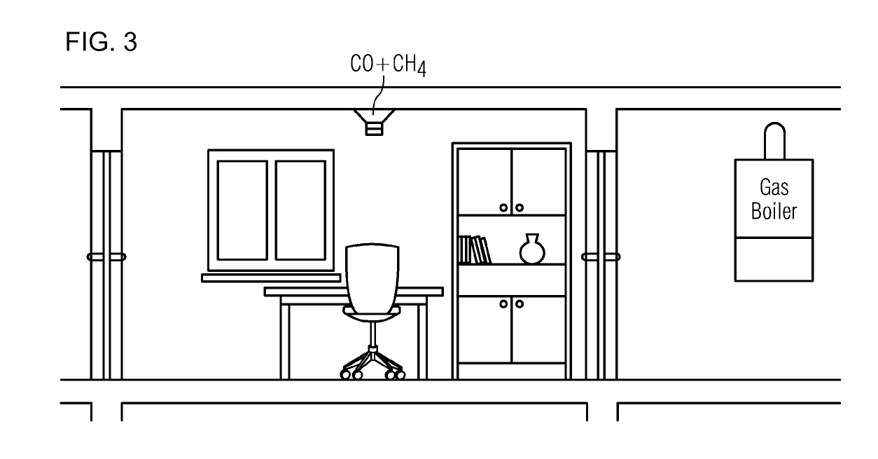

FIG. 3 shows the installation site in a living room, which is connected to the operating room of a gas heating system/gas boiler.

With a VCSEL as the light source, various applications can be opened up. The essential advantage achievable over the prior art is that much shorter measurement times are made possible for determining concentrations of at least two gases to be measured. Furthermore, substantially less technical outlay is required than for methods or devices according to the prior art.

The operation of firing systems can thereby be adjusted optimally. In this context, a characteristic carbon monoxide concentration plays a substantial role.

This lies for example at a few tens of ppm CO, for example 14 ppm. With a carbon monoxide concentration measurement, the optimal combustion status can be monitored and controlled. The greatest possible efficiency is thereby achieved, and the emission of undesired pollutants is minimized.

The simultaneous detection of carbon monoxide and methane concentrations makes it possible to produce an extended function of monitoring gas burners for undesired operating statuses.

A monitoring function registers both the carbon monoxide concentration and the methane concentration in an exhaust gas, and takes place such that with an increasing oxygen deficit during the combustion, the carbon monoxide concentration rises to above the explosion limit. With a further increased oxygen deficit, unburnt hydrocarbons, for example methane, also enter the exhaust gas. The carbon monoxide concentration may in this case fall again. In other words, a hazardous operating status cannot be identified unequivocally merely by monitoring the carbon monoxide concentration. Only the simultaneous measurement of carbon monoxide and methane allows reliable identification of the respective operating status. If for example there is a combustible gas mixture in the exhaust gas path, then this hazardous operating status can be detected directly.

If for example a gas boiler is installed in a private household, then in particular two potential risk sources arise:

a. Leakage of the supplied combustible gas, for example natural gas.
b. Escape of carbon monoxide from the combustion into the air in the room.

Both scenarios again and again lead to accidents with serious damage.

A device for carrying out a method corresponding to the invention requires a tunable monochromatic light source, for example a VCSEL, and an absorption path and a photodiode. The gas to be studied is located in the absorption measurement path. Using the monochromatic and spectrally tunable light source, the absorption spectrum of the gas mixture present in the measurement path would be recorded by the photodetector. The target gases are carbon monoxide CO and methane CH₄.

The proposed wavelength of the laser source may, for example, be 2.35 μm. The laser diode remains monochromatic, but can be tuned in a fine range so that an absorption spectrum of a gas to be measured can be recorded. In principle, any wavelength range in which carbon monoxide and methane absorb may be used. The absorption spectrum is analyzed for the concentrations of the individual gases in the gas mixture. This is done, for example, by comparing the measured spectrum with a calculated spectrum of the gas mixture.

In order to obtain reference values, a reference gas cell is fitted in a measurement gas path. Pre-absorption with a gas takes place in it. The reference gas cell may be arranged directly in the gas flow or alternatively in a separate light path. In the latter case, it would contain a part of the radiation of the light from the main flow.

A separate reference gas cell can be obviated if the housing of the photodetector and/or the housing of the light source is filled with the reference gas and light beam is correspondingly guided through.

The reference gas consists either of at least one of the target gases or at least one further gas which absorbs in the measurement spectrum. In this case for example, a target gas may be determined, an atom of the gas being replaced by an isotope. Gas mixtures consisting of more than two components are possible.

The concentration measurement of carbon monoxide is used for combustion to be as optimal as possible with respect to efficiency and to avoid undesired emissions of for example carbon monoxide and nitrogen oxide, and to avoid unburnt hydrocarbons. For the control, the volume flow of air is supplied to the combustion and adjusted as a function of the measured CO concentration.

Hazardous operating statuses are, for example, associated with an explosion risk. These operating statuses can be identified by the exceeding of fixed limit values, for example the MWC values/maximum workplace concentration.

Hazardous operating statuses may, for example, be identified from:

A carbon monoxide concentration which exceeds a fixed limit value, a methane concentration which exceeds a fixed limit value, or another characteristic development of the carbon monoxide and methane concentrations as a function of time.

Besides carbon monoxide and methane, the concentration of water or water vapor may also be used to assess the status of a firing system. The combustion exhaust gas contains several percent by volume of water vapor. In the event of incomplete combustion, the moisture concentration on extinction of the flame decreases to the value of ambient air, about 1 vol %.

FIG. 1 represents an absorption spectrum which can be scanned by a tunable VCSEL in the range of from 2.363 to 2.368 μm, the bands of carbon monoxide/10 ppm, methane/85 ppm and water/1200 ppm being scanned. At the same time, the numerical values indicate the measured concentration.

FIG. 2 shows the installation site of a CO/CH₄ sensor in the exhaust gas of a gas or oil burner, which can be controlled by means of the CO content. For safety reasons, the methane content may be determined simultaneously in order to detect other critical operating statuses.

FIG. 3 shows the installation site in a living room, which is connected to the operating room of a gas heating system/gas boiler, in which case a smoke detector may additionally be installed or integrated. The target gases, including water vapor, are lighter than air so that fitting on the ceiling is expedient.

1-15. (canceled)

16. A method for controlling or monitoring firing systems and for monitoring buildings having gas burners using spectroscopy, the method comprising the following steps:
providing at least one wavelength-tunable monochromatic light source;
recording an absorption spectrum of a gas to be measured with at least one photodetector in an absorption path by spectral tuning of the light source; and
simultaneously determining concentrations of carbon monoxide (CO) and methane (CH₄) as target gases during the tuning of the light source.

17. The method according to claim 16, which further comprises using a laser diode as the light source.

18. The method according to claim 16, which further comprises using a VCSEL (vertical cavity surface emitting laser) as the light source.

19. The method according to claim 16, which further comprises tuning a light source or laser diode with a wavelength of 2.3 μm, and simultaneously scanning absorption lines of carbon monoxide and methane.

20. The method according to claim 16, which further comprises carrying out an analysis of an absorption spectrum with the aid of the concentration measured for the target gases.

21. The method according to claim 16, which further comprises providing a reference gas cell directly or in a bypass light path for pre-absorption with a gas.

22. The method according to claim 21, wherein a gas present in the reference gas cell contains at least one target gas.

23. The method according to claim 16, which further comprises positioning the absorption path in at least one of an exhaust gas downstream of a firing system or a room or operating room of a gas boiler to be monitored.

24. The method according to claim 16, which further comprises monitoring the gas concentrations of the target gases for predetermined maximum values.

25. The method according to claim 16, which further comprises monitoring a characteristic carbon monoxide concentration of less than 100 ppm to maximize efficiency of the firing system.

26. The method according to claim 16, which further comprises carrying out control and monitoring with a monitoring function with the aid of concentration profiles of carbon monoxide and methane as a function of time.

27. The method according to claim 26, which further comprises preventing explosion limits from being reached on the basis of the concentration measurement of the two gases.

28. The method according to claim 16, which further comprises monitoring both a leak of a combustible gas supplied to a firing system and containing proportions of methane, and a leak of carbon monoxide escaping from a firing system into room air.

29. The method according to claim 16, which further comprises selecting the light source with respect to its frequency so as to also scan and analyze a characteristic band of water (H₂O) during the tuning of the light source, to assess a status of a firing system.

30. The method according to claim 16, which further comprises monitoring at least one of a carbon monoxide concentration exceeding a set limit value combined with the concentration of methane exceeding a fixed limit value, or a characteristic profile of the carbon monoxide and methane concentrations as a function of time, to avoid hazardous operating statuses.

31. A device for carrying out a method of controlling or monitoring firing systems and monitoring buildings having gas burners using spectroscopy, the device comprising:
a monochromatic laser or semiconductor laser;
an absorption path positioned in an exhaust gas region or in a room at risk of leakage;
a photodetector for recording light having passed through said absorption path; and
an analysis unit for determining at least one of a presence or concentration of target gases from an absorption spectrum scanned by tuning said laser or semiconductor laser, for carrying out the method according to claim 16.

32. The device according to claim 30, wherein said laser is a VCSEL.
